(19) United States
(12) Patent Application Publication
(10) Pub. No.: US 2008/0290617 A1
(43) Pub. Date: Nov. 27, 2008

(54) Gas suspension system and method

(75) Inventor: Joseph A. Bounds, Fishers, IN (US)

Correspondence Address: BRIDGESTONE AMERICAS HOLDING, INC., 1200 FIRESTONE PARKWAY, AKRON, OH, 44317, US

(73) Assignee: BFS Diversified Products, LLC

(21) Appl. No.: 11/805,030

(22) Filed: May 22, 2007

(51) Int. Cl. B60G 17/044

(52) U.S. Cl. 280/5.5

(57) ABSTRACT

A method of operating a gas suspension system includes generating a first quantity of gas having a storage pressure and transferring the first quantity of gas into the pressurized gas storage device such that a second quantity of gas having approximately the storage pressure remains in a transfer pathway. The method also includes determining that a condition exists for venting gas from the gas spring assembly and placing the second quantity of gas into fluid communication with a quantity of gas having said spring pressure. The method further includes waiting until an approximately equilibrium pressure has been reached, and then actuating a third control device to exhaust at least a portion of the gas from the suspension system. A gas suspension system adapted to perform the method is also included.

### BACKGROUND

The subject matter of the present disclosure broadly relates to the art of gas suspension systems and, more particularly, to a gas suspension system and method capable of venting gas at reduced exhaust pressures.

The subject matter of the present disclosure finds particular application and use in conjunction with suspension systems of wheeled vehicles, and will be shown and described herein with reference thereto. However, it is to be appreciated that the subject matter of the present disclosure is also amenable to other applications and environments, and that the specific uses shown and described herein are merely exemplary. For example, the subject matter of the present disclosure could be used in support structures, height adjusting systems and actuators associated with industrial machinery, components thereof and/or other such equipment. Accordingly, the subject matter of the present disclosure is not intended to be limited to use associated with vehicle suspensions.

Gas suspension systems, such as for use on vehicles, for example, are known to provide the capability of adjusting the height and/or alignment (i.e., leveling) of a sprung mass (e.g., a body or chassis of a vehicle) relative to an unsprung mass thereof (e.g., a wheel-engaging member or axle housing of the vehicle). As such, known gas suspension systems commonly transfer pressurized gas into and out of gas spring assemblies, which are operatively connected between the sprung and unsprung masses. In this manner, the gas suspension system can alter or otherwise adjust the height and/or alignment of the sprung mass relative to the unsprung mass.

However, there are certain problems and/or disadvantages associated with the operation of known systems and which, in particular, involve this transfer of pressurized gas through various areas and/or portions of the gas suspension system. More specifically, known gas suspension systems typically include a pressurized gas source (e.g., a compressor), a pressurized gas storage chamber (e.g., a reservoir), one or more gas spring assemblies, and one or more control devices (e.g., valve assemblies) capable of controlling the transfer of pressurized gas between two or more of the other components. As a result of such transfer operations, it is common for a relatively small quantity of relatively high pressure gas to become trapped within pathways, chambers and other volumes within the system. This relatively high pressure gas is typically generated due to an action or operation involving the pressurized gas source and/or the pressurized gas storage chamber, both of which normally operate at significantly increased pressure levels in comparison to the pressure level of the gas spring assemblies.

One difficulty with such residual high-pressure gas is that the same is commonly trapped in, along or otherwise in fluid communication with the exhaust pathway of the gas suspension system. As such, upon initiating an action in which gas is to be exhausted from the system, this relatively high-pressure residual gas reaches the exhaust port of the system and is normally vented to an external pressure (e.g., atmospheric pressure). Due to the increased pressure level thereof relative to that of the gas spring assemblies, the venting of this residual gas can generate noise levels that are significantly increased over those generated by the venting of gas that is at or near spring pressure levels. These increased noise levels are, of course, undesirable and to be avoided in many known gas suspensions systems.

Another difficulty with trapping such relatively-high pressure residual gas within a gas suspension system is that at least the control device that is operative to open and close the exhaust port will be subjected to relatively-high differential pressures (i.e., the pressure difference between that of the residual gas and the external pressure). As such, a larger and more substantial control device is normally used to withstand this relatively-high differential pressure and to increase operational reliability and/or performance of the control device. However, the use of a larger control device is normally associated with increases in size, weight, power consumption and component costs. All of which are normally considered to be undesirable in known gas suspension systems.

As an alternative to simply using a more robust control device, other gas suspension systems are known to use a separate circuit to bleed off any such relatively-high pressure residual gas within the system prior to opening the exhaust control device. One example of such a system is shown and described in U.S. Pat. No. 6,726,224. However, the use of a separate bleed-off circuit also has numerous disadvantages. For example, the use of a separate circuit to bleed off this high-pressure residual gas necessitates the use of additional components, such as one or more additional control devices, for example. Typically, such components are significantly smaller than those used for performing the primary exhaust functions. Nonetheless, such arrangements will normally increase component and production costs, and can also result in performance disadvantages.

Accordingly, it is believed desirable to develop a gas suspension system and method of operation that overcomes the forgoing and other problems and disadvantages.

### BRIEF DESCRIPTION

One exemplary method of operating a gas suspension system in accordance with the present novel concept is provided that includes providing a gas suspension system suitable for use between a sprung mass and an unsprung mass. The gas suspension system includes a gas spring assembly that is operatively connected between the sprung and unsprung masses and that contains a quantity of gas having a spring pressure. The gas suspension system also includes a pressurized gas source that is operative to generate pressurized gas and a pressurized gas storage device that is capable of receiving and storing a quantity of gas having a storage pressure. The gas suspension system also includes a transfer pathway that is capable of fluidically communicating with the gas spring assembly, the pressurized gas source and the pressurized gas storage device. The gas suspension system also includes a first control device that is operatively connected along the transfer pathway for selectively controlling pressurized gas transfer into and out of the pressurized gas storage device, and a second control device that is operatively connected along the transfer pathway for selectively controlling pressurized gas transfer into and out of the gas spring assembly. The gas suspension system also includes a third control device that is operatively connected along the transfer pathway for selectively controlling pressurized gas transfer through an exhaust port. The gas suspension system also includes a control system in communication with the pressurized gas source and the first, second and third control devices. The control system is also operative to selectively actuate the pressurized gas source, operative to selectively actuate the first, second and third control devices, and operative to at least determine if conditions exist that are appropriate for venting gas from the gas spring assembly. The method also includes generating a first quantity of gas having the storage pressure, using the pressurized gas source, and transferring the first quantity of gas into the pressurized gas storage device through the transfer pathway such that a second quantity of gas having approximately the storage pressure remains in the transfer pathway. The method further includes determining, using the control system, that a condition exists for venting gas from the gas spring assembly. The method also includes actuating the second control device and thereby placing the second quantity of gas having approximately the storage pressure and the quantity of gas having the spring pressure in fluid communication with one another. The method further includes waiting until the second quantity of gas having approximately the storage pressure and the quantity of gas in the gas spring assembly having the spring pressure have approximately reached an equilibrium pressure that is less than the storage pressure. The method also includes actuating the third control device to place the quantity of gas at the equilibrium pressure in fluid communication with the exhaust port and thereby exhausting at least a portion of the gas at the equilibrium pressure.

Another exemplary method of operating a gas suspension system in accordance with the present novel concept is provided that includes providing a gas suspension system suitable for use on a vehicle having a sprung mass and an unsprung mass. The gas suspension system includes a gas spring assembly that is operatively connected between the sprung and unsprung masses and that contains a quantity of gas having a spring pressure. The gas suspension system also includes a pressurized gas source that is operative to generate pressurized gas and a pressurized gas storage device that is capable of receiving and storing a quantity of gas having a storage pressure. The gas suspension system further includes a transfer pathway that is capable of fluidically communicating with the gas spring assembly, the pressurized gas source and the pressurized gas storage device. The gas suspension assembly also includes a first control device that is in operative communication along the transfer pathway for selectively controlling pressurized gas transfer into and out of the pressurized gas storage device and a second control device that is in operative communication along the transfer pathway for selectively controlling pressurized gas transfer into and out of the gas spring assembly. The gas suspension assembly further includes a control system in communication with the pressurized gas source and the first and second control devices. Additionally, the control system is operative to selectively actuate the pressurized gas source, operative to selectively actuate the first and second control devices, and operative to at least determine if conditions exist that are appropriate for venting gas from the gas spring assembly. The method also includes generating gas having approximately the storage pressure, using the pressurized gas source. The method further includes opening the first control device to place the pressurized gas storage device into fluid communication with the pressurized gas source through the transfer pathway and thereby transfer a first quantity of gas having approximately the storage pressure into the pressurized gas storage device through the transfer pathway. The method also includes closing the first control device to thereby retain the first quantity of pressurized gas in the pressurized gas storage device, and determining using the control system that a condition exists for transferring gas into the gas spring assembly. The method further includes opening the first and second control devices to place the pressurized gas storage device and the gas spring assembly in fluid communication with one another through the transfer pathway and thereby transfer at least a portion of the first quantity of pressurized gas at approximately the storage pressure into the transfer pathway and the gas spring assembly. The method also includes determining using the control system that a sufficient quantity of gas has been transferred to the gas spring assembly, closing the first control device to fluidically disconnect the pressurized gas storage device from the transfer pathway, and waiting for the quantity of gas in the transfer pathway and the quantity of gas in the gas spring assembly to approximately reach an equilibrium pressure approximately equal to the spring pressure. The method further includes closing the second control device such that the gas spring assembly is fluidically disconnected from the transfer pathway and the residual quantity of gas in the transfer pathway has a pressure that is approximately equal to the spring pressure.

One exemplary embodiment of a gas suspension system in accordance with the present novel concept for use between an associated sprung mass and an associated unsprung mass of an associated vehicle is provided that includes a gas spring assembly operatively connected between the associated sprung and unsprung masses. The gas spring assembly contains a first quantity of gas having a spring pressure. A pressurized gas storage device is capable of receiving and storing pressurized gas having a storage pressure, and a pressurized gas source is capable of generating pressurized gas having a pressure of at least the storage pressure. A transfer pathway is capable of fluidically communicating with the gas spring assembly, the pressurized gas source and the pressurized gas storage device. A first control device is in operative communication along the transfer pathway for selectively controlling pressurized gas transfer into and out of the pressurized gas storage device. A second control device is in operative communication along the transfer pathway for selectively controlling pressurized gas transfer into and out of the gas spring assembly. A third control device is in operative communication along the transfer pathway for selectively controlling pressurized gas transfer through an exhaust port. Additionally, a control system is in communication with the pressurized gas source and the first, second and third control devices. The control system is adapted to energize the pressurized gas source and thereby generate a second quantity of gas having at least the storage pressure. The control system is also adapted to actuate the first control device and thereby place the pressurized gas storage device in fluid communication with the pressurized gas source through the transfer pathway such that the second quantity of gas having at least the storage pressure can be received in the pressurized gas storage device. The control system is further adapted to de-energize the pressurized gas source and de-actuate the first control device such that the second quantity of gas can be retained in the pressurized gas storage device with a third quantity of gas having approximately the storage pressure remaining within the transfer pathway. The control system is also adapted to determine that a condition exists for venting a portion of the first quantity of gas at the spring pressure from the gas spring assembly and to actuate the second control device and thereby place the gas spring assembly in fluid communication with the transfer pathway such that the first and third quantities of gas can be fluidically combined. The control system is further adapted to wait a preprogrammed period of time that is sufficient for the first and third quantities of gas to approximately reach an equilibrium pressure that is less than the storage pressure, and to actuate the third control device to place the gas at the equilibrium pressure in fluid communication with the exhaust port and thereby vent at least a portion of the gas at the equilibrium pressure from the gas suspension system.

### BRIEF DESCRIPTION OF THE DRAWINGS

FIG. 1 is a schematic representation of one exemplary embodiment of a vehicle suspension system in accordance with the present novel concept.

FIG. 2 is a graphical representation of one exemplary method of operating a gas suspension system in accordance with the present novel concept.

FIG. 3 is a graphical representation of pressure versus time for a portion of a transport pathway of a gas suspension system under operation in accordance with the method in FIG. 2.

FIG. 4 is another graphical representation of pressure versus time for a portion of a transport pathway of a gas suspension system under operation in accordance with the method in FIG. 2.

### DETAILED DESCRIPTION

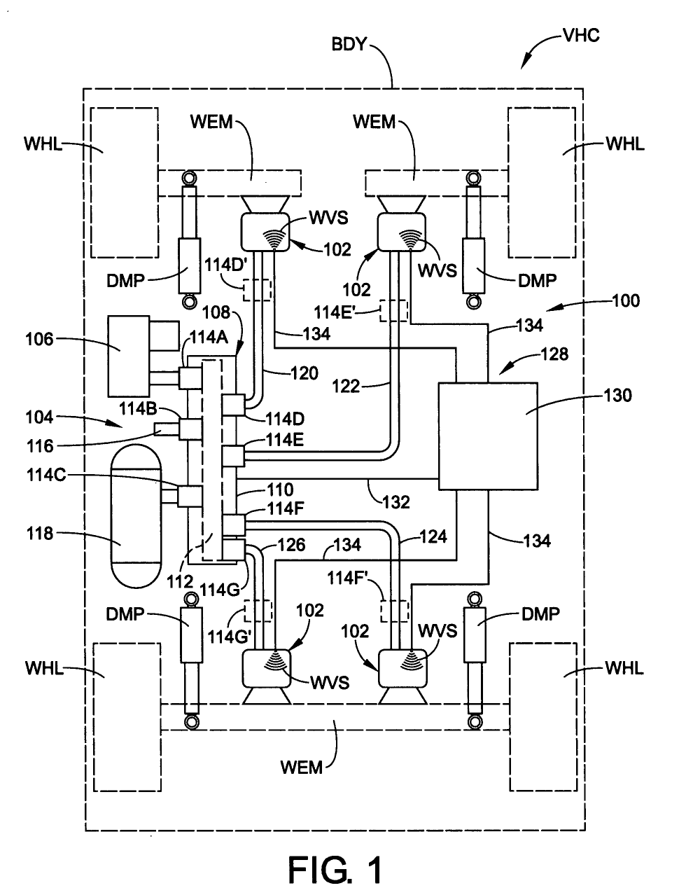

Turning now to the drawings, wherein the showings are for the purpose of illustrating exemplary embodiments of the present novel concept and not for the purpose of limiting the same, FIG. 1 illustrates one embodiment of a suspension system 100 disposed between a sprung mass, such as an associated vehicle body BDY, for example, and an unsprung mass, such as an associated wheel WHL or an associated wheel-engaging member WEM, for example, of an associated vehicle VHC. It will be appreciated that any such suspension system can include any number of one or more systems, components and/or devices and that the same can be operatively connected between the sprung and unsprung masses of the associated vehicle in any suitable manner. For example, such a suspension system can include a plurality of damping members, such as dampers DMP, for example, that can be operatively connected between the sprung and unsprung masses of the associated vehicle in any suitable manner.

A suspension system according to the present novel concept includes a plurality of gas spring assemblies that are supported between the sprung and unsprung masses of the associated vehicle. In the embodiment shown in FIG. 1, suspension system 100 includes four gas spring assemblies 102, one of which is shown disposed toward each corner of the associated vehicle adjacent a corresponding wheel WHL. However, it will be appreciated that any other suitable number of gas spring assemblies could alternately be used in any other suitable configuration or arrangement. As shown in FIG. 1, gas spring assemblies 102 are supported between wheel-engaging members WEM and body BDY of associated vehicle VHC. It will be recognized that the gas spring assemblies shown and described herein (e.g., gas spring assemblies 102) are of a rolling lobe-type construction. However, it will be appreciated that the present novel concept can be utilized in association with any other suitable arrangement and/or construction of gas spring assembly and that those gas spring assemblies shown and described herein are merely exemplary. Additionally, it will be appreciated that the gas spring assemblies can be operative at any suitable spring pressure, such as from about 60 psig to about 120 psig, for example.

Suspension system 100 also includes a pressurized gas system 104 that is operatively associated with the gas spring assemblies for selectively supplying pressurized gas (e.g., air) thereto and selectively transferring pressurized gas therefrom. In the exemplary embodiment shown in FIG. 1, gas system 104 includes a pressurized gas source, such as a compressor 106, for example, for generating quantities of air or other gases at relatively high gas pressures, such as at pressure levels of 150 psig or greater, for example. The pressurized gas system can also include any number of one or more control devices of any suitable type, kind and/or construction as may be capable of effecting the selective transfer of pressurized gas between any two or more components of the suspension system. For example, gas system 104 is shown as including a valve assembly 108 that is fluidically connected to and between a variety of components, such as gas spring assemblies 102 and compressor 106, for example. It will be appreciated that valve assembly 108 can be of any suitable type, kind and/or construction.

As an example, in the embodiment shown in FIG. 1, valve assembly 108 includes a manifold or valve block 110 with a fluid transfer chamber 112 formed therein and a plurality of valves (and valve actuators) 114A-G operatively associated with the valve block. The plurality of valves is adapted to selectively place a corresponding plurality of valve block ports or openings (not shown) in fluid communication with fluid transfer chamber 112. Alternately, manifold 110 could simply be a fitting or connector block with one or more of the plurality of control devices physically and/or fluidically spaced from any such connector block, as indicated by valves 114D′-114G′, for example.

It will be appreciated that the suspension system can include control devices, such as valves 114A-G, for example, of any suitable type, kind and/or construction, such as direct-acting solenoid valves or pilot-actuated valves, for example. Additionally, it will be appreciated that the control devices can be used in any suitable combination and/or arrangement, and can be operatively associated between any two or more components or fluidically distinct portions of the pressurized gas system. For example, valve 114A is shown as being in fluid communication between compressor 106 and transfer chamber 112. While it will be recognized that due to the nature of operation of a typical pressurized gas source, such as compressor 106, the use of a control device to isolate the compressor from the transfer passage can normally be avoided. However, in some arrangements, the pressurized gas source could also include an exhaust passage or other feature for which selective fluid communication would be beneficial. As such, valve assembly 108 can optionally include valve 114A.

Rather than including the exhaust passage together with the compressor, gas system 104 can include a separate muffler 116 or other exhaust component in communication with valve assembly 108. In such case, an exhaust valve 114B can be disposed in fluid communication between the muffler and transfer chamber 112 for selectively controlling fluid communication therebetween and thereby selectively controlling the venting of pressurized gas from the suspension system. Additionally, pressurized gas system 104 also includes a pressurized gas storage device, such as a reservoir 118, for example, capable of storing a quantity of gas at a relatively high storage or reservoir pressure, such as at a gas pressure of about 150 psig or greater, for example. In the exemplary embodiment shown in FIG. 1, reservoir 118 is in fluid communication with transfer chamber 112 of valve block 110 through reservoir valve 114C, which is operative to selectively control the flow of pressurized gas into and out of the reservoir.

As discussed above, pressurized gas system 104 is also in fluid communication with gas spring assemblies 102 and can be connected thereto in any suitable manner. For example, valve assembly 108 can be in communication with gas spring assemblies 102 through transfer lines 120-126, each of which can be fluidically connected to an opening or port (not shown) in valve block 110. Additionally, valves 114D-G (or, alternately, valves 114D′-114G′) can be in fluid communication between transfer chamber 112 and transfer lines 120-126, respectively. As such, pressurized gas can be selectively transferred to and/or from the gas spring assemblies through transfer chamber 112 of valve assembly 110 by selectively actuating and de-actuating or otherwise opening and closing valves 114D-G. It will be recognized that such transfers of pressurized gas can be used to alter or maintain vehicle height at one or more corners of the vehicle (e.g., to perform leveling or height changing operations).

As used herein, a transport pathway refers to any volume or combination of volumes within the pressurized gas system that are placed into fluid communication between two components or fluidically distinct portions of the gas system and through which pressurized gas can flow from one component or fluidically distinct portion to the other component or fluidically distinct portion. Thus, the size, configuration or operating envelope of a transport pathway will change from application-to-application, such as for different suspension systems, for example, and will also normally change from operation-to-operation of any given application, such as may depend on which particular components and/or fluidically discrete portions of a given suspension system are used for a given gas transfer action, for example. Additionally, it will be appreciated that as a result of any given transfer of pressurized gas between two components or fluidically discrete portions of the gas system, a quantity of residual pressurized gas will normally remain trapped or otherwise retained within the transfer pathway.

As an example, by opening valves 114A (if provided) and 114C, compressor 106 and reservoir 118 can be placed into fluid communication with one another such that pressurized gas can be transferred into the reservoir from the compressor. It will be recognized that in the present exemplary embodiment such a transfer would occur primarily by way of transfer chamber 112. As such, the transport pathway for this application would primarily include transfer chamber 112, and a quantity of residual gas would normally remain trapped within this exemplary transport pathway. Additionally, it will be further recognized that under such normal conditions of operation the quantity of residual gas will likely have a relatively high pressure level, such as approximately the reservoir pressure, for example.

As another example, by opening valves 114C and 114D, reservoir 118 and gas spring assembly 102 (through transfer line 120) can be placed into fluid communication with one another such that relatively high pressure gas from the reservoir can be transferred into the gas spring assembly. It will be recognized that in the present exemplary embodiment such a transfer will primarily occur through transfer chamber 112 (with transfer line 120 remaining at spring pressure and, thus, being considered part of the gas spring assembly for purposes of this example). As such, the transport pathway for this application would primarily include transfer chamber 112, and the quantity of residual gas that will be trapped within this exemplary transport pathway, under conventional operating conditions, would again have a relatively high pressure level, such as approximately reservoir pressure, for example.

As a further example, by opening valve 114A (if provided) and any combination of valves 114D′-114G′, compressor 106 and gas spring assemblies 102 can be placed into fluid communication with one another such that gas at approximately spring pressure can be transferred into the gas spring assemblies from the compressor. It will be recognized that in the present exemplary embodiment such a transfer would primarily occur through transfer chamber 112 and transfer lines 120-126. As such, the transport pathway associated with this operation would primarily include transfer chamber 112 and the portions of transfer lines 120-126 that are respectively disposed between manifold 110 and valves 114D′-114G′. It will, then, be recognized that under normal operating conditions the quantity of residual gas trapped within this exemplary transport pathway would have a lower relative pressure, such as approximately spring pressure, for example.

In light of the foregoing examples, it is to be understood that the transport pathway can and will vary from application-to-application and from operation-to-operation in any given application, depending on which control devices are being opened/closed and which components are being communicated between. Furthermore, though it may not be apparent from FIG. 1, the transport pathway will normally be substantially smaller in overall volume than other components of the gas suspension system, such as reservoir 118 and gas spring assemblies 102, for example.

Suspension system 100 also includes a control system 128 that is capable of communicating with any of one or more other systems and/or components (not shown) of suspension system 100 for selective operation and control thereof. It will be appreciated that control system 128 can be in communication with such one or more systems and/or components in any suitable manner, such as by using directly communicated electrical signals (e.g., via hardwired connections) or communication signals transmitted via a vehicle or system network, for example. Control system 128 includes a controller or electronic control unit (ECU) 130 in communication with compressor 106 and valve assembly 108, such as through a conductor or lead 132, for example, for selective operation and control of the compressor and the valve assembly. In one embodiment, ECU 130 is in communication with each of valves 114A-G for selective operation and control (e.g., opening and closing) thereof. As such, by selectively actuating and de-actuating valves 114A-G, any one or more of the other components or fluidically discrete areas of the pressurized gas system can be placed into fluid communication with transfer chamber 112.

Control system 128 can also optionally include one or more height or distance sensing devices (not shown) as well as any other desired systems and/or components. Such height sensors, if provided, are preferably capable of generating or otherwise outputting a signal having a relation to a height or distance, such as between spaced components of the vehicle, for example. It will be appreciated that such optional height sensors or any other distance-determining devices, if provided, can be of any suitable type, kind, construction and/or configuration, such as mechanical linkage sensors, ultrasonic wave sensors or electromagnetic wave sensors, such as may operate using ultrasonic or electromagnetic waves WVS, for example. Additionally, it will be appreciated that distance-indicating signals output or otherwise generated by such height sensors can be communicated to ECU 130 in any suitable manner, such as through leads 134, for example. Furthermore, control system 128 can include any other suitable sensors or devices as may be known in the art. For example, one or more pressure sensors (not shown) can be included in operative association with any one or more portions of the system for generating signals indicative of gas pressures in those one or more portions of the system.

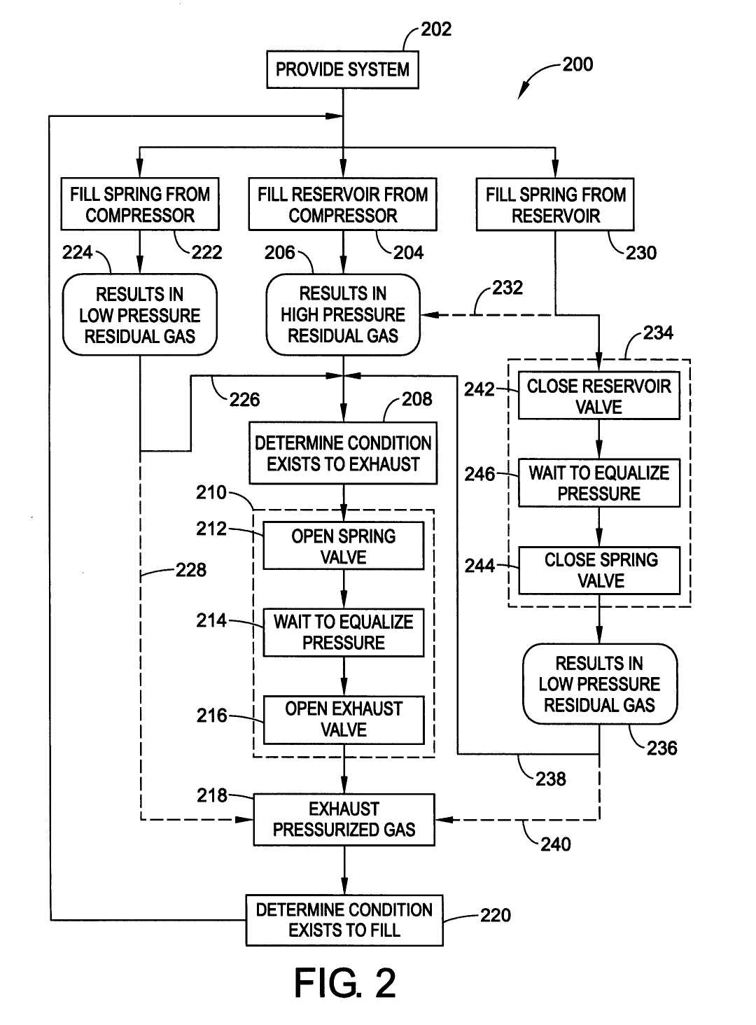

FIG. 2 illustrates one exemplary method of operation 200 in accordance with the present novel concept that includes providing a suspension system, such as suspension system 100, for example, that is capable of performing the subject method, as indicated by box 202. As discussed above, a suitable suspension system, such as suspension system 100, will normally be capable of transferring pressurized gas into and/or between various combinations of suspension system components. One commonality between these various transfers of pressurized gas is that the same normally include transfers through a transfer pathway of the suspension system. As a result, the gas pressure within the transfer pathway can vary from very low pressure levels (e.g., approximately zero (0) gage pressure) to substantially higher pressure levels, such as storage or reservoir pressures (e.g., approximately 150 psig or greater), for example.

One example of such a transfer of pressurized gas includes filling or otherwise transferring pressurized gas into a pressurized gas storage device, such as reservoir 118 (FIG. 1), for example, from a pressurized gas source, such as compressor 106 (FIG. 1), for example, as indicated by box 204 in FIG. 2. As discussed above, such an action normally results in residual high pressure gas remaining in the transfer pathway, as indicated by box 206.

During normal use and operation, the control system of the suspension system will occasionally determine that conditions are appropriate for initiating a leveling action for adjusting the leveled orientation of the sprung mass of the vehicle. Such a determination can be made in any suitable manner as may be known in the art, and is generally indicated by box 208 in FIG. 2. Once it is determined that a leveling action should be initiated, particularly any leveling action that would involve exhausting or otherwise venting pressurized gas from the system, the pressure of the residual gas within the transfer pathway is preferably reduced to a lower pressure level prior to initiation of any such exhaust or venting action, as indicated by box 210. One benefit of lowering the pressure level within the transfer pathway is that the noise level of the pressurized gas venting through the exhaust pathway can be substantially reduced. Additionally, reduced pressure levels can also have less detrimental impact on the associated exhaust valve and/or other components.

It will be appreciated that the pressure reduction indicated by box 210 can be performed in any suitable manner. As one exemplary series of actions for performing such a pressure reduction, one or more control devices, such as one or more of spring valves 114D-G, for example, can, as indicated by box 212, be actuated or otherwise opened to place the residual high-pressure gas that is trapped or otherwise retained within the transfer pathway into fluid communication with a corresponding one or more of the gas spring assemblies (e.g., gas spring assemblies 102), which are normally at a lower relative gas pressure, such as approximate spring pressure, for example.

Additionally, it may be desirable to wait a predetermined period of time before executing any further actions to allow the high pressure gas within the transfer pathway to at least approximately reach an equilibrium pressure with the pressurized gas in the one or more gas spring assemblies, as indicated by box 214. It will be appreciated that in some cases, the transfer pathway may contain only a very small quantity of residual high-pressure gas that would approximately reach an equilibrium pressure in a substantially short period of time, such as from about 100 milliseconds to about 500 milliseconds, for example. In other situations, however, the transfer pathway may contain a more significant quantity of residual high-pressure gas. In such situations, it may take a more substantial amount of time for an approximately equilibrium pressure to be reached, such as from about 500 milliseconds to about 5000 milliseconds, for example. As such, it will be appreciated that any suitable predetermined waiting period can be used.

Once the pressure level of the residual gas in the transfer pathway has been sufficiently reduced, such as by waiting until the same has approximately reached an equilibrium pressure with the corresponding one or more gas spring assemblies, a control device, such as exhaust valve 114B, for example, can be actuated or otherwise opened, as indicated by box 216. It will be appreciated that this action will permit the pressurized gas to be exhausted or otherwise vented from the system, as indicated by box 218, such as to adjust a leveled condition of the sprung mass of the vehicle, for example. Upon exhausting or otherwise venting pressurized gas to an external atmosphere, it will be appreciated that the pressure within the transfer pathway will be at a relatively low level, such as approximately zero (0) psig, for example. As such, any further exhausting of pressurized gas could be performed without repeating the action of reducing gas pressure within the transfer pathway, such as is presented in box 210, for example.

Eventually, however, the control system of the suspension system will determine that a condition exists to fill or otherwise transfer pressurized gas into or between components of the suspension system, as indicated by box 220 in FIG. 2. Any such fill action will normally result in residual pressurized gas being retained in the transfer pathway of the gas system of the suspension system, such as gas system 104 of suspension system 100, for example. It will be recalled, however, that the level of such residual pressurized gas will depend on the fill action that is performed. As discussed above, an action of transferring pressurized gas from a pressurized gas source into a pressurized gas storage device, as indicated by box 204, can result in relatively high pressure gas being trapped or otherwise retained in the transfer pathway, as indicated by box 206.

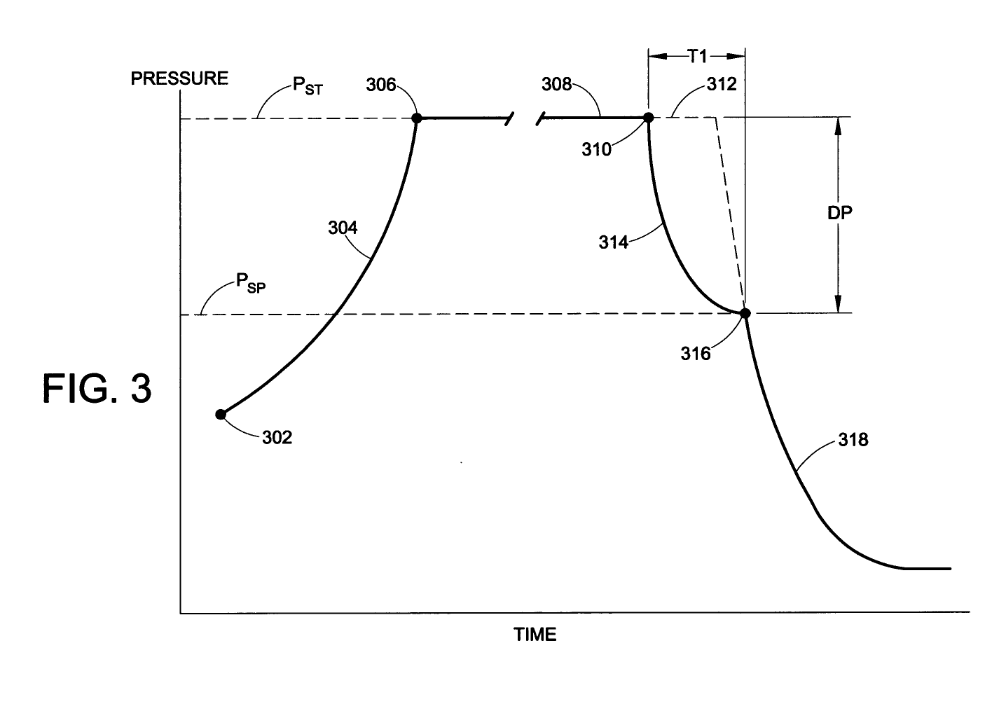

Turning, briefly, to FIG. 3, an exemplary graphical representation of pressure versus time is shown for gas within a transfer pathway during a fill operation in which pressurized gas is transferred into a pressurized gas storage device (e.g., reservoir 118) from a pressurized gas source (e.g., compressor 106) and then subsequently vented to an external atmosphere. Initially, the compressor is energized or otherwise started and the reservoir valve (e.g., valve 114C) is actuated or otherwise opened, as indicated by point 302, and the pressure level of gas within the transfer pathway will increase, as indicated by line 304. Upon the gas within the reservoir reaching a suitable, relatively-high pressure level, such as storage or reservoir pressure P_{ST}, for example, the compressor can be de-energized or otherwise stopped and the reservoir valve can be de-actuated or otherwise closed, as indicated by point 306, in accordance with known methods of operation.

As indicated by line 308 in FIG. 3, the pressure of the quantity of residual gas within the transfer pathway will remain at a relatively high level until it is determined that a condition exists for exhausting or otherwise venting pressurized gas from the system, which is represented by point 310. Under a conventional method of operation, relatively high pressure residual gas, as indicated by dashed line 312, would be exhausted to the external atmosphere. According to one exemplary method of operation in accordance with the subject novel concept, however, one or more spring valves (e.g., one or more of valves 114D-G) can be actuated or otherwise opened to place the residual gas within the transfer pathway in fluid communication with a corresponding one or more of the gas spring assemblies, as indicated by box 212 in FIG. 2. This action permits the relatively high pressure residual gas within the transfer pathway to combine with the relatively low pressure gas within the gas spring assembly or assemblies. This thereby reduces the pressure level of the quantity of residual gas toward an equilibrium pressure, such as approximately spring pressure P_{SP}, for example, as indicated by line 314.

Once the pressure level of the quantity of residual gas in the transfer pathway has approximately reached an equilibrium pressure with one or more of the gas spring assemblies, as indicated by point 316, the exhaust valve (e.g., one of valves 114A and 114B) can be actuated or otherwise opened and the now relatively low pressure gas in the transfer pathway, along with any other quantities of gas (e.g., gas from the gas spring assemblies), can be exhausted from the system to the external atmosphere, as indicated by line 318. It will be appreciated that the determination to actuate or otherwise open the spring valve or valves can be made in any suitable manner. As one example, it may be desirable to wait a predetermined period of time, such as is indicated by dimension T1, to permit the quantities of gas to approximately reach an equilibrium pressure. Additionally, it will be appreciated that the pressure level of the gas that is vented to the external atmosphere, which is shown as being approximately equal to spring pressure P_{SP}, is significantly reduced compared to the pressure level of gas in known systems, which is indicated by dashed line 312. This reduction in pressure, which is indicated by dimension DP, results in a significant reduction in noise during the exhaust process. Additionally, other benefits (e.g., reductions in seal degradation) can be achieved without the use of additional components or more robust configuration.

In other fill actions, however, the residual pressurized gas may be at a lower relative pressure level, such as from about 60 to about 120 psig, for example. One example of such a fill action involves transferring pressurized gas from the pressurized gas source (e.g., compressor 106) into one or more of the gas spring assemblies (e.g., gas spring assemblies 102), as indicated by box 222. The resulting relatively low pressure level of the residual pressurized gas, which can be approximately equal to spring pressure P_{SP} as is indicated by box 224, can be exhausted or otherwise vented from the suspension system by attempting to further reduce the gas pressure in the manner discussed above, as indicated by arrow 226. Alternately, as indicated by arrow 228, the residual low-pressure gas could optionally be exhausted or otherwise vented from the system using a different method of operation.

In addition to fill action 204, other known methods of operation will also normally result in the residual pressurized gas within the transfer pathway being at a relatively high pressure level. One example of such a fill action involves transferring pressurized gas from the pressurized gas storage device (e.g., reservoir 118) to one or more of the gas spring assemblies (e.g., gas spring assemblies 102), as indicated by box 230. As previously discussed, however, such fill actions, when performed using conventional and otherwise known methods of operation, will typically result in relatively high pressure residual gas being trapped or otherwise retained in the transfer pathway, as indicated by arrow 232.

As an alternative method of operation, in accordance with another aspect of the present novel concept, method 200 includes preventing the retention of residual gas at relatively high pressure within the transfer pathway, as indicated by box 234, which results in the residual gas within the transfer pathway having a relatively low pressure level (i.e., spring pressure), as indicated by box 236. The resulting relatively low pressure gas can be exhausted or otherwise vented from the suspension system by attempting to further reduce the gas pressure in the manner presented above, as indicated by arrow 238. Alternately, as indicated by arrow 240, the residual low-pressure gas could optionally be exhausted or otherwise vented from the system using a different method of operation.

It will be appreciated that preventing the retention of relatively high pressure residual gas within the transfer pathway, as indicated by box 234, can be accomplished in any suitable manner or method of operation. One example of a method of preventing the retention of relatively high-pressure gas within the transfer pathway during a fill operation that involves the transfer of pressurized gas from a reservoir to one or more gas springs includes closing the associated reservoir valve (e.g., reservoir valve 114C), as indicated by box 242, prior to closing the associated spring valve or valves (e.g., one or more of spring valves 114D-G), as indicated by box 244. In this manner, the residual gas in at least a significant portion of the transfer pathway will equalize at approximately spring pressure rather than at approximate reservoir pressure, as is the case in known systems. Optionally, method 200 can also include waiting a predetermined period of time for the residual gas to approximately reach an equilibrium pressure, as indicated by box 246. As discussed above with regard to box 214, any suitable predetermined period of time can be used, such as from about 100 milliseconds to about 5000 milliseconds, for example, depending upon the volume of pressurized gas within the transfer pathway as well as other suitable factors.

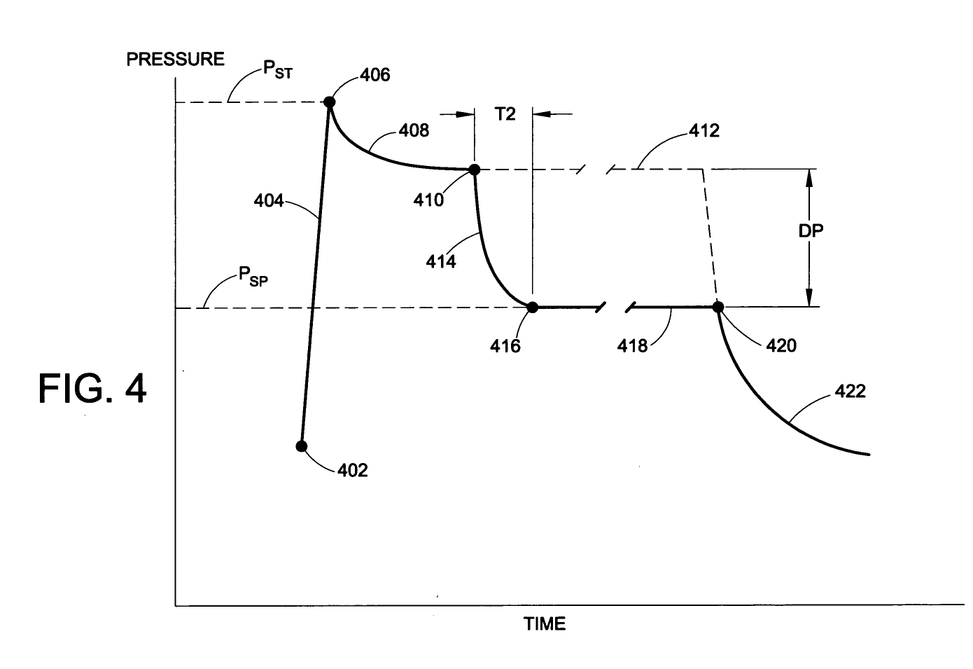

Turning now to FIG. 4, an exemplary graphical representation of pressure versus time is shown for gas within a transfer pathway during a fill operation in which pressurized gas from a pressurized gas storage device (e.g., reservoir 118) is transferred into a gas spring assembly (e.g., gas spring assemblies 102). During the fill operation, the control system will actuate or otherwise open the reservoir valve (e.g., valve 114C), as indicated by point 402, and the pressure level of the transfer pathway will quickly increase to approximately the storage or reservoir pressure P_{ST}, as indicated by line 404. Upon actuating or otherwise opening one or more of the spring valves (e.g., one or more of valves 114D-G), as indicated by point 406, the pressure within the transfer pathway will be reduced to a slightly lower pressure level, as indicated by line 408.

Upon reaching the time to discontinue the fill operation, which is indicated in FIG. 4 by point 410, a conventional or known method of operation will commonly close the reservoir and spring valves approximately simultaneously, which action traps or otherwise retains a quantity of residual pressurized gas within the transport pathway. Due to the approximately simultaneous closing of the reservoir and spring valves, the pressure level of the quantity of residual gas remains relatively high, as indicated by dashed line 412. In other arrangements, the spring valve or valves may be closed prior to the closing of the reservoir valve. Such an action can, in some cases, result in an undesired increase in the pressure level of the residual gas in the transfer pathway.

In accordance with one aspect of the present novel concept, however, method 200 is operative to prevent the retention of such relatively high-pressure gas and is instead operative to significantly reduce the pressure level of the quantity of residual gas within the transfer pathway. More specifically, the reservoir valve is closed at point 410 to thereby discontinue the transfer of pressurized gas from the reservoir to one or more of the gas springs, as indicated by box 242 in FIG. 2. Thereafter, the pressure level of the quantity of residual gas in the transfer decreases, as indicated by line 414, toward the gas pressure in one or more of spring assemblies, which pressure is shown in FIG. 4 as being approximate spring pressure P_{SP}. Upon the quantity of residual gas at least approximately reaching the equilibrium pressure, as indicated by point 416, the spring valve or valves (e.g., one or more of valves 114D-G) can be closed, as indicated by box 244 in FIG. 2.

The determination to close the spring valve or valves can be made in any suitable manner, such as by waiting a predetermined period of time T2, as indicated by box 246 in FIG. 2. Thereafter, a relatively low pressure, such as approximate spring pressure P_{SP}, for example, can be maintained in the transfer pathway as indicated by line 418. At some future time, as represented by point 420, it will be determined that conditions exist for exhausting pressurized gas from the suspension system, as indicated by box 208 in FIG. 2. An action to exhaust the pressurized gas can then be performed, as indicated by line 422 in FIG. 4. It will be appreciated that the pressure level of the gas vented to the external atmosphere (as represented by line 418) is significantly reduced compared to that of known systems (as represented by 412), as indicated by arrow DP. Thus, significant noise reduction and other benefits can be achieved without the use of additional components or more robust configurations.

As used herein with reference to certain elements, components and/or structures (e.g., “first end member” and “second end member”), numerical ordinals merely denote different singles of a plurality and do not imply any order or sequence unless specifically defined by the claim language. Additionally, the term “gas” is used herein to broadly refer to any gaseous or vaporous fluid. Most commonly, air is used as the working medium of suspension systems and the components thereof, such as those described herein. However, it will be understood that any suitable gaseous fluid could alternately be used.

While the subject novel concept has been described with reference to the foregoing embodiments and considerable emphasis has been placed herein on the structures and structural interrelationships between the component parts of the embodiments disclosed, it will be appreciated that other embodiments can be made and that many changes can be made in the embodiments illustrated and described without departing from the principles of the subject novel concept. Obviously, modifications and alterations will occur to others upon reading and understanding the preceding detailed description. Accordingly, it is to be distinctly understood that the foregoing descriptive matter is to be interpreted merely as illustrative of the present novel concept and not as a limitation. As such, it is intended that the subject novel concept be construed as including all such modifications and alterations insofar as they come within the scope of the appended claims and any equivalents thereof.

1. A method of operating a gas suspension system, said method comprising:
a) providing a gas suspension system suitable for use between a sprung mass and an unsprung mass, said gas suspension system including:
a gas spring assembly operatively connected between the sprung and unsprung masses and containing a quantity of gas having a spring pressure;
a pressurized gas source operative to generate pressurized gas;
a pressurized gas storage device capable of receiving and storing a quantity of gas having a storage pressure;
a transfer pathway capable of fluidically communicating with said gas spring assembly, said pressurized gas source and said pressurized gas storage device;
a first control device operatively connected along said transfer pathway for selectively controlling pressurized gas transfer into and out of said pressurized gas storage device;
a second control device operatively connected along said transfer pathway for selectively controlling pressurized gas transfer into and out of said gas spring assembly; and,
a third control device operatively connected along said transfer pathway for selectively controlling pressurized gas transfer through an exhaust port;
a control system in communication with said pressurized gas source and said first, second and third control devices, and said control system operative to selectively actuate said pressurized gas source, operative to selectively actuate said first, second and third control devices, and operative to at least determine if conditions exist that are appropriate for venting gas from said gas spring assembly;
b) generating a first quantity of gas having said storage pressure using said pressurized gas source and transferring said first quantity of gas into said pressurized gas storage device through said transfer pathway such that a second quantity of gas having approximately said storage pressure remains in said transfer pathway;
c) determining using said control system that a condition exists for venting gas from said gas spring assembly;
d) actuating said second control device and thereby placing said second quantity of gas having approximately said storage pressure and said quantity of gas having said spring pressure in fluid communication with one another;
e) waiting until said second quantity of gas having approximately said storage pressure and said quantity of gas in said gas spring assembly having said spring pressure have approximately reached an equilibrium pressure that is less than said storage pressure; and,
f) actuating said third control device to place said quantity of gas at said equilibrium pressure in fluid communication with said exhaust port and thereby exhausting at least a portion of said gas at said equilibrium pressure.

2. A method according to claim 1 further comprising:
g) determining using said control system that a condition exists for filling gas into said gas spring assembly;
h) actuating said first and second control devices to place said quantity of gas in said pressurized gas storage device having said storage pressure and said quantity of gas in said gas spring assembly having said spring pressure in fluid communication with one another through said transfer pathway and thereby transfer gas from said pressurized gas storage device to said gas spring assembly;
i) actuating said first control device to isolate said pressurized gas storage device from said transfer pathway;
j) waiting until a remaining quantity of gas in said transfer pathway and said quantity of gas in said gas spring assembly approximately reach an equilibrium pressure of approximately said gas spring pressure; and,
k) actuating said second control device to isolate said gas spring assembly from said transfer pathway such that said remaining quantity of gas in said transfer pathway is maintained at approximately said gas spring pressure.

3. A method according to claim 2, wherein one of waiting until said second quantity of gas having approximately said storage pressure and said quantity of gas in said gas spring assembly having said spring pressure have approximately reached an equilibrium pressure in e) and waiting until said remaining quantity of gas in said transfer pathway and said quantity of gas in said gas spring assembly approximately reach an equilibrium pressure in j) includes waiting a duration of from about 100 to about 5000 milliseconds.

4. A method according to claim 1, wherein a) includes providing a distance-indicating sensor in communication with said control system and capable of generating a signal having a relation to a distance between the sprung and unsprung mass, and j) includes determining that a condition exists for venting gas from said gas spring assembly based at least in part on said signal from said distance-indicating sensor.

5. A method according to claim 1, wherein b) includes opening said first control device to transfer said first quantity of gas from said pressurized gas source into said pressurized gas storage device through said transfer pathway and then closing said first control device and thereby retaining said second quantity of gas having approximately said storage pressure in said transfer pathway.

6. A method according to claim 1, wherein f) includes exhausting at least a portion of said quantity of gas in said gas spring assembly having said spring pressure through said exhaust port.

7. A method of operating a gas suspension system, said method comprising:
a) providing a gas suspension system suitable for use on a vehicle having a sprung mass and an unsprung mass, said gas suspension system including:
a gas spring assembly operatively connected between the sprung and unsprung masses and containing a quantity of gas having a spring pressure;
a pressurized gas source operative to generate pressurized gas;
a pressurized gas storage device capable of receiving and storing a quantity of gas having a storage pressure;
a transfer pathway capable of fluidically communicating with said gas spring assembly, said pressurized gas source and said pressurized gas storage device;
a first control device in operative communication along said transfer pathway for selectively controlling pressurized gas transfer into and out of said pressurized gas storage device;
a second control device in operative communication along said transfer pathway for selectively controlling pressurized gas transfer into and out of said gas spring assembly; and,
a control system in communication with said pressurized gas source and said first and second control devices, and said control system operative to selectively actuate said pressurized gas source, operative to selectively actuate said first and second control devices, and operative to at least determine if conditions exist that are appropriate for venting gas from said gas spring assembly;
b) generating gas having approximately said storage pressure using said pressurized gas source;
c) opening said first control device to place said pressurized gas storage device into fluid communication with said pressurized gas source through said transfer pathway and thereby transfer a first quantity of gas having approximately said storage pressure into said pressurized gas storage device through said transfer pathway;
d) closing said first control device to thereby retain said first quantity of pressurized gas in said pressurized gas storage device;
e) determining using said control system that a condition exists for transferring gas into said gas spring assembly;
f) opening said first and second control devices to place said pressurized gas storage device and said gas spring assembly in fluid communication with one another through said transfer pathway and thereby transfer at least a portion of said first quantity of pressurized gas at approximately said storage pressure into said transfer pathway and said gas spring assembly;
g) determining using said control system that a sufficient quantity of gas has been transferred to said gas spring assembly;
h) closing said first control device to fluidically disconnect said pressurized gas storage device from said transfer pathway;
i) waiting for said quantity of gas in said transfer pathway and said quantity of gas in said gas spring assembly to approximately reach an equilibrium pressure approximately equal to said spring pressure; and,
j) closing said second control device such that said gas spring assembly is fluidically disconnected from said transfer pathway and said residual quantity of gas in said transfer pathway has a pressure that is approximately equal to said spring pressure.

8. A method according to claim 7, wherein a) includes providing a third control device in operative communication along said transfer pathway for selectively controlling pressurized gas transfer through an exhaust port, said control system in communication with and operative to selectively actuate said third control device, said method further comprising opening said third control device to place at least said residual quantity of gas in said transfer pathway in communication with an external atmosphere through said exhaust port.

9. A method according to claim 7 further comprising:
k) creating a residual quantity of gas having approximately said storage pressure within said transfer pathway;
l) determining using said control system that a condition exists for exhausting gas from said gas spring assembly;
m) opening said second control device and thereby placing said quantity of gas in said gas spring assembly and said residual quantity of gas in said transfer pathway in fluid communication with one another; and,
n) after performing m), opening said third control device to place said quantity of gas in said gas spring assembly and said residual quantity of gas in said transfer pathway in communication with an external atmosphere through said exhaust port.

10. A method according to claim 9 further comprising waiting until said quantity of gas in said gas spring assembly and said residual quantity of gas in said transfer pathway approximately reach an equilibrium pressure that is less than said storage pressure after opening said second control device in m) and prior to opening said third control device in n).

11. A method according to claim 10, wherein waiting until said quantity of gas in said gas spring assembly and said residual quantity of gas in said transfer pathway approximately reach an equilibrium pressure includes waiting from approximately 100 to approximately 5000 milliseconds.

12. A gas suspension system for use between an associated sprung mass and an associated unsprung mass of an associated vehicle, said gas suspension system comprising:
a gas spring assembly operatively connected between the associated sprung and unsprung masses, said gas spring assembly containing a first quantity of gas having a spring pressure;
a pressurized gas storage device capable of receiving and storing pressurized gas having a storage pressure;
a pressurized gas source capable of generating pressurized gas having a pressure of at least said storage pressure;
a transfer pathway capable of fluidically communicating with said gas spring assembly, said pressurized gas source and said pressurized gas storage device;
a first control device in operative communication along said transfer pathway for selectively controlling pressurized gas transfer into and out of said pressurized gas storage device;
a second control device in operative communication along said transfer pathway for selectively controlling pressurized gas transfer into and out of said gas spring assembly;
a third control device in operative communication along said transfer pathway for selectively controlling pressurized gas transfer through an exhaust port; and,
a control system in communication with said pressurized gas source and said first, second and third control devices, said control system adapted to:
energize said pressurized gas source and thereby generate a second quantity of gas having at least said storage pressure;
actuate said first control device and thereby place said pressurized gas storage device in fluid communication with said pressurized gas source through said transfer pathway such that said second quantity of gas having at least said storage pressure can be received in said pressurized gas storage device;
de-energize said pressurized gas source and de-actuate said first control device such that said second quantity of gas can be retained in said pressurized gas storage device with a third quantity of gas having approximately said storage pressure remaining within said transfer pathway;
determine that a condition exists for venting a portion of said first quantity of gas at said spring pressure from said gas spring assembly;
actuate said second control device and thereby place said gas spring assembly in fluid communication with said transfer pathway such that said first and third quantities of gas can be fluidically combined;
wait a preprogrammed period of time that is sufficient for said first and third quantities of gas to approximately reach an equilibrium pressure that is less than said storage pressure; and,
actuate said third control device to place said gas at said equilibrium pressure in fluid communication with said exhaust port and thereby vent at least a portion of said gas at said equilibrium pressure from said gas suspension system.

13. A gas suspension system according to claim 12, wherein at least one of said first, second and third control devices includes a valve assembly having a valve body disposed in fluid communication along said transport pathway and an actuator operatively connected to said valve body and in communication with said control system for selective operation thereof.

14. A gas suspension system according to claim 13, wherein said first and second control devices include each include a valve assembly having a valve body and an actuator, each of said valve bodies being disposed on a common valve block that includes a block cavity, each of said valve bodies being displaceable between an open condition and a closed condition.

15. A gas suspension system according to claim 14, wherein said transport pathway includes said block cavity.

16. A gas suspension system according to claim 12, wherein said gas spring assembly is one of a plurality of gas spring assemblies operatively connected between the associated sprung mass and the associated unsprung mass, said second control device is one of a plurality of second control devices in operative communication along said transfer pathway, and each of said plurality of gas spring assemblies is in fluid communication with said transfer pathway through one of said plurality of second control devices.

17. A gas suspension system according to claim 12, wherein said control system includes a height sensor adapted to generate a signal having a relation to a distance between the associated sprung and unsprung masses, said control system being adapted to determine that a condition exists for venting a portion of said first quantity of gas from said gas spring assembly based at least in part on said signal.

18. A gas suspension system according to claim 12, wherein said control system includes a controller in communication with said pressurized gas source and said first, second and third control devices, said controller adapted to selectively energize and de-energize said pressurized gas source, adapted to selectively actuate and de-actuate said first, second and third control devices, adapted to determine that a condition exists for venting a portion of said first quantity of gas from said gas spring assembly, and adapted to wait said predetermined period for said first and third quantities of gas to approximately reach an equilibrium pressure.

19. A gas suspension system according to claim 18, wherein said controller is adapted to wait for a predetermined period of from about 100 to about 5000 milliseconds.

20. A gas suspension system according to claim 18, wherein said control system includes a height sensor adapted to generate a signal having a relation to a distance between the associated sprung and unsprung masses, said controller being in communication with said height sensor and operative to receive said signal therefrom, and said controller being adapted to determine that a condition exists for venting a portion of said first quantity of gas from said gas spring assembly based at least in part on said signal.
